(19) United States
(12) Patent Application Publication
(10) Pub. No.: US 2010/0096867 A1
(43) Pub. Date: Apr. 22, 2010

(54) PICKUP DEVICE FOR ANIMAL WASTE

(76) Inventor: Douglas G. Flinn, Naples, FL (US)

Correspondence Address: GOLD & RIZVI, P.A., 600 N. PINE ISLAND ROAD, SUITE 450, PLANTATION, FL, 33324-1311, US

(21) Appl. No.: 12/581,850

(22) Filed: Oct. 19, 2009

Related U.S. Application Data
(63) Continuation-in-part of application No. 12/288,426, filed on Oct. 21, 2008.

(51) Int. Cl. A01K 29/00

(52) U.S. Cl. 294/1.4

(57) ABSTRACT

A foldable device having a grip subassembly, a waste collection subassembly, and a handle extension disposed therebetween. The waste subassembly includes an upper section, a lower section and a pivot subassembly pivotally assembly the upper and lower sections. A trigger is pivotally assembled within the grip subassembly. Pair of waste handling arms are pivotally assembled to the waste collection subassembly. A cable is provided between the trigger and the pair of waste handling arms for operating the waste handling arms. A bag is removably assembled to the waste handling arms for sanitary collection of any animal excrement.

### CROSS-REFERENCE TO RELATED APPLICATION

This Continuation-In-Part application claims the benefit of co-pending United States Non-Provisional patent application Ser. No. 12/288,426, filed on Oct. 21, 2008, which is incorporated herein in its entirety.

### FIELD OF THE INVENTION

The present invention relates to a pickup device for animal waste, and more particularly, to a pickup device comprising a segmented handle pivotally joined having a trigger control at an upper end in communication with a movable animal waste handling gripper at a lower end via a cable.

### BACKGROUND OF THE INVENTION

The invention pertains to an animal waste handling device that can be used in an easy procedure and in a completely sanitary manner. Many cities and other municipalities have ordinances that require pet owners, who take their pets for a walk, to pick up their pet's droppings such as feces to maintain the environment in a sanitary condition. These ordinances, including courtesy and common sense, apply to public properties as well as private properties. With the increased public concern over a cleaner and a more sanitary environment, many municipalities have required dog owners to retrieve and properly dispose of their animal's feces on both public and private properties. Although this is most pleasant for the public, it directs the pet's owners with an extremely unpleasant task of retrieving and disposing of the excrement.

Various devices are known to accomplish the above mentioned mandate. Many scooping devices are available which keep a collection bag open while the feces is scraped or scooped therein. In a first known method, the pet owner wears a glove, fabricated of a plastic or other sanitary material, on the hand. The glove is simply used to manually pick up the droppings, and then by inverting the glove or by stripping the glove off the hand to invert the same, the droppings are contained within the plastic glove and then disposed of in a sanitary manner. In another known method, the pet owner carries a small shovel and/or bucket or a similar container to accomplish the same task as noted above. An advantage of this process is that the pet owner does not have to handle the excrement, while a drawback is the method requires the cleaning of the tools afterwards.

Other known methods utilize more complicated devices that accomplish the pick up and disposal of animal droppings in a more distal and sanitary manner.

U.S. Pat. No. 4,097,082 to Orofino teaches a device that accomplishes the above noted task. The implement described in this patent consists of an electrometric band to automatically close over the mouth of a flexible wrapper which is operated by two side plates that will swing inwardly at their bottoms to thereby grab the flexible wrapper having the animal dropping contained therein and to thereafter dispose the same, all in a sanitary manner.

U.S. Pat. No. 5,628,537 to Kiemer teaches a similar device. This patent discloses a device that also uses a pair of jaws that are pivotally attached at one end of a long handle. An elongated sleeve is connected to the jaws around the handle. When the jaws are locked in an open state, a bag clip engages the closed end of an ordinary thin plastic bag, while the open end of the bag is inverted over the edges of the jaws. To pick up the dog feces, the user positions the open bag over the waste, makes the jaws contact the ground, rotates the sleeve to unlock a sliding motion and moves the sleeve downward on the handle. This closes the jaws and encloses the waste within the bag to be disposed of at a later time and in a sanitary manner.

U.S. Pat. No. 6,305,322 to Patel teaches a waste pickup device consisting of an elongated tubular handle having an interior manipulator therein. At the end is a tubular casing. The interior handle can manipulate claws that can be retracted into the tubular casing. The claw consists of four claw elements that can receive a paper medium therein. The claw elements will pick up the feces and together with the paper is retracted to within the casing to thereby pick up the waste.

Accordingly, there remains a need in the art for a device that provides a sanitary method for collecting and disposing of pet excrement.

### SUMMARY OF THE INVENTION

The present invention overcomes the deficiencies of the known art and the problems that remain unsolved by providing an animal waste pick up device, which gathers and deposits the excrement into a waste disposal bag.

The invention consists of an elongated handle that can be reduced in length by folding one half of the handle over the other handle half when not in use. At a forward end of the handle there is located a claw consisting of two claw elements. The claw elements can be activated from the other end of the handle by way of a trigger that tensions a cable which tension is transferred to the jaw elements to open or close the same. In an open state, the two claw elements receive a paper bag that is fastened to each of the claw elements. A compression spring assures that the claw elements remain in a closed state when not in use.

In accordance with one embodiment of the present invention, there is provided an animal waste pick up device, the device comprising:

a handle subassembly comprising:
an upper handle section,
a lower handle section, and
a pivot subassembly which pivotally assembles the upper handle section and the lower handle section together, allowing the upper handle section and the lower handle section to be folded for a reduced overall length of the device;

a grip subassembly comprising:
a grip housing,
a trigger pivotally assembled to the grip housing, and
a biasing member which maintains the trigger in an extended state; and

a waste collection subassembly comprising:
a sliding arm control sleeve being slideably assembled to the distal end of the lower handle section,
a pair of waste handling arms, each comprising a waste handling frame and a cam element extending from angularly from a pivot aperture, the waste handling arms being pivotally assembled to the sliding arm control sleeve,
a cam pivot connector providing pivotal attachment of the cam element of each of the pair of waste handling arms to the sliding arm control sleeve; and

an operating control cable having a first end attached to the sliding arm control sleeve and a second end attached to the trigger.

In one aspect, the present invention comprises a bag passage through at least one waste handling arm.

Yet another aspect, the pivot subassembly further comprises a latch and catch for maintaining the upper handle section and lower handle section in a linear arrangement.

While another aspect, the a handle grip extension of the grip is releasable engaging with a handle catch aperture provided through the waste collection assembly for securing the animal waste pick up device in a folded configuration.

With yet another aspect, a waste disposal bag being positioned through the Regarding another aspect, an opening of the waste disposal bag being wrapped about an exterior portion of the handling arms of the waste collection assembly.

In yet another aspect, the waste disposal bag includes a closure string provided about a bag opening and the animal waste pick up device includes a hook for securing the closure string away from the collection portion of the device.

In another aspect, wherein the waste disposal bag is secured to a waste handling arm inner surface provided upon a collection end portion of a waste arm frame.

Yet another aspect, wherein the waste disposal bag is secured to the waste handling arm inner surface via a tacky media.

Continuing with another recognized aspect of the present invention; the waste disposal bag is secured to the waste handling arm inner surface via a dense hook and loop fastening system.

With yet another aspect, the waste handling device includes a biasing system for maintaining the waste collection subassembly in a normally closed configuration.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an isometric view of the full length of an animal waste handling device;

FIG. 2 presents an isometric view of the animal waste handling device of FIG. 1 shown in a folded configuration;

FIG. 3 presents a detailed sectional view of the handle portion of the animal waste handling device including a handle pivot subassembly, a trigger, and a cable activator;

FIG. 4 presents a sectional view of the animal waste handling device detailing the operation of the handle pivot subassembly and the engagement of a grip portion into a waste handling subassembly for storage;

FIG. 5 presents a sectional view of the waste handling subassembly of the animal waste handling device in an open state for collection of animal waste;

FIG. 6 presents a sectional view of the waste handling subassembly of the animal waste handling device in a closed state for containment of collected animal waste;

FIG. 7 presents an isometric view detailing a first step of assembling a waste collection bag onto the waste handling subassembly;

FIG. 8 presents an isometric view detailing a second step of assembling the waste collection bag onto the waste handling subassembly;

FIG. 9 presents an isometric view detailing a third step of assembling the waste collection bag onto the waste handling subassembly;

FIG. 10 presents an isometric view detailing a forth step of assembling the waste collection bag onto the waste handling subassembly;

FIG. 11 presents an isometric view detailing a fifth step of assembling the waste collection bag onto the waste handling subassembly;

FIG. 12 presents an isometric view detailing a sixth step of assembling the waste collection bag onto the waste handling subassembly utilizing an adhesive material; and

FIG. 13 presents an isometric view detailing a sixth step of assembling the waste collection bag onto the waste handling subassembly utilizing a dense hook and loop tape fastening configuration.

Like reference numerals refer to like parts throughout the several views of the drawings.

### DETAILED DESCRIPTION

Detailed embodiments of the present invention are disclosed herein. It will be understood that the disclosed embodiments are merely exemplary of the invention that may be embodied in various and alternative forms. The figures are not necessarily to scale, and some features may be exaggerated or minimized to show details of particular embodiments, features, or elements. Specific structural and functional details, dimensions, or shapes disclosed herein are not limiting but serve as a basis for the claims and for teaching a person of ordinary skill in the art the described and claimed features of embodiments of the present invention. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

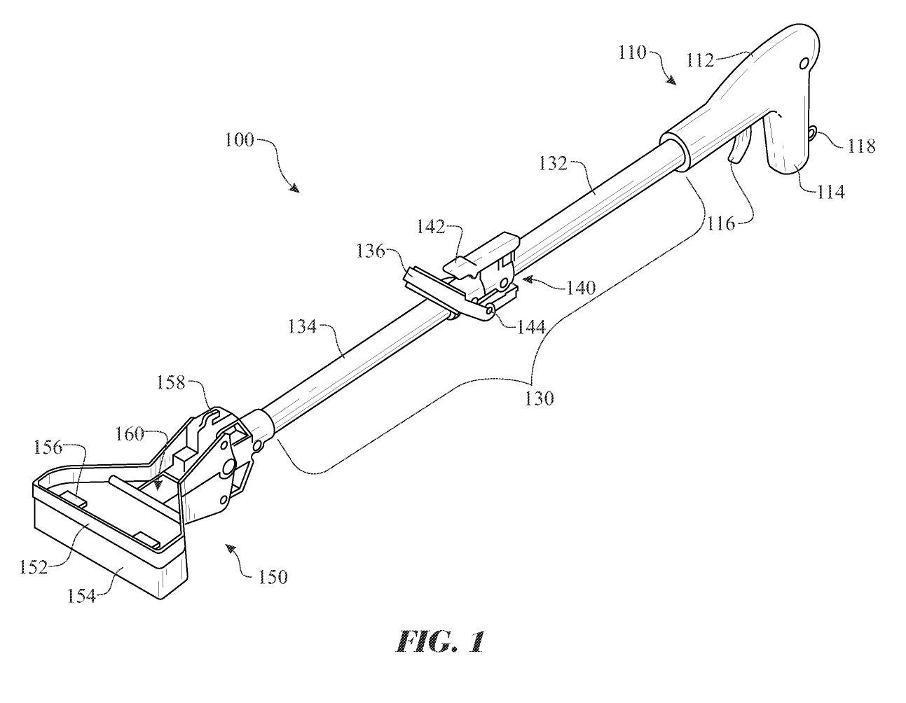

For purposes of description herein, the terms “upper”, “lower”, “left”, “rear”, “right”, “front”, “vertical”, “horizontal”, and derivatives thereof shall relate to the invention as oriented in FIG. 1, where applicable. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

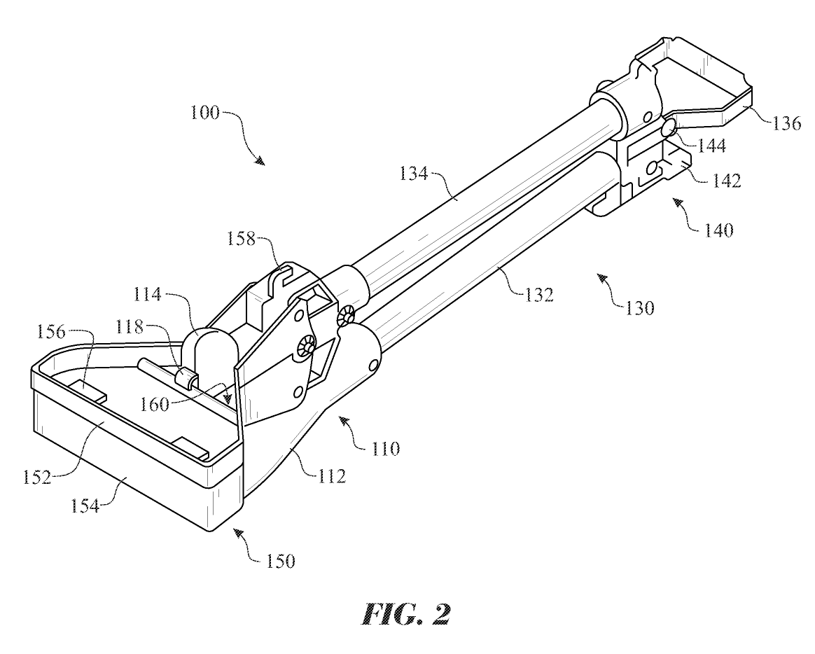

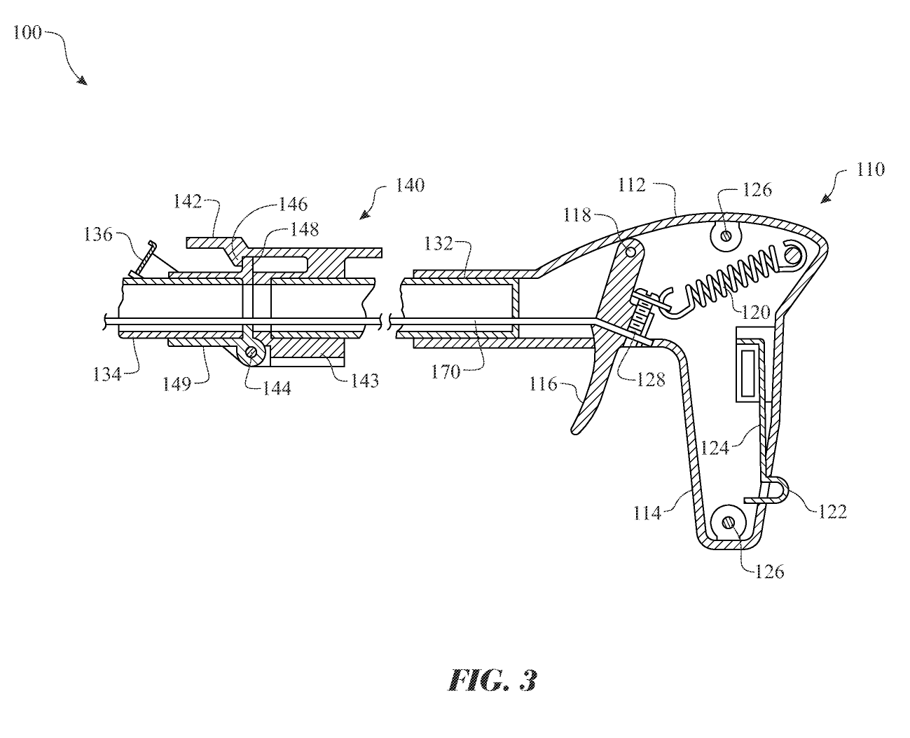

An exemplary embodiment of the present invention is represented as an animal waste handling device 100 providing descriptive illustrations shown in FIGS. 1 through 6. The device can be segmented into three subassemblies: a grip subassembly 110, a handle extension subassembly 130, and a waste collection subassembly 150. The animal waste handling device 100 includes a handle pivot subassembly 140 allowing the handle extension subassembly 130 to be folded proximate a midsection, reducing an overall length for handling and storage.

The grip subassembly 110 is fabricated having a grip housing 112 comprising a first side and a second side being assembled by any reasonable means know by those skilled in the art. The grip housing 112 is preferably fabricated of a molded plastic and shaped including a handle grip extension 114. The user would operate the animal waste handling device 100 by holding the handle grip extension 114. The illustration presents a pair of grip assembly fasteners 126, provided along an upper edge and a lower edge. The fasteners can be of any known acceptable style, including threaded fasteners, snap fasteners, rivets, ultrasonic welds, and the like. An optional tongue and groove (not shown) can be provided about a perimeter ensuring proper registration, deterring any dust and dirt intrusion, among other benefits. A trigger pivot pin 118 can be provided within the grip housing 112 for pivotally assembling a trigger 116 to the grip subassembly 110. The trigger 116 is biased into a normal position via a trigger biasing member 120. In the exemplary embodiment, the trigger biasing member 120 is a compression spring. A tension spring, having a light tensile force, can be used as an alternate embodiment, utilising a biasing member 168 (detailed later) as a primary biasing member. A grip closure latch 122 can be provided along the handle grip extension 114 as a means for securing the grip subassembly 110 in a stored configuration, as will be described in detail later herein. The grip closure latch 122 can be a grip latching element of any reasonable form factor, including a notch formed within the grip housing 112, a cantilevered clip (incorporating a grip latch spring 124 as illustrated), a ball detent, and the like.

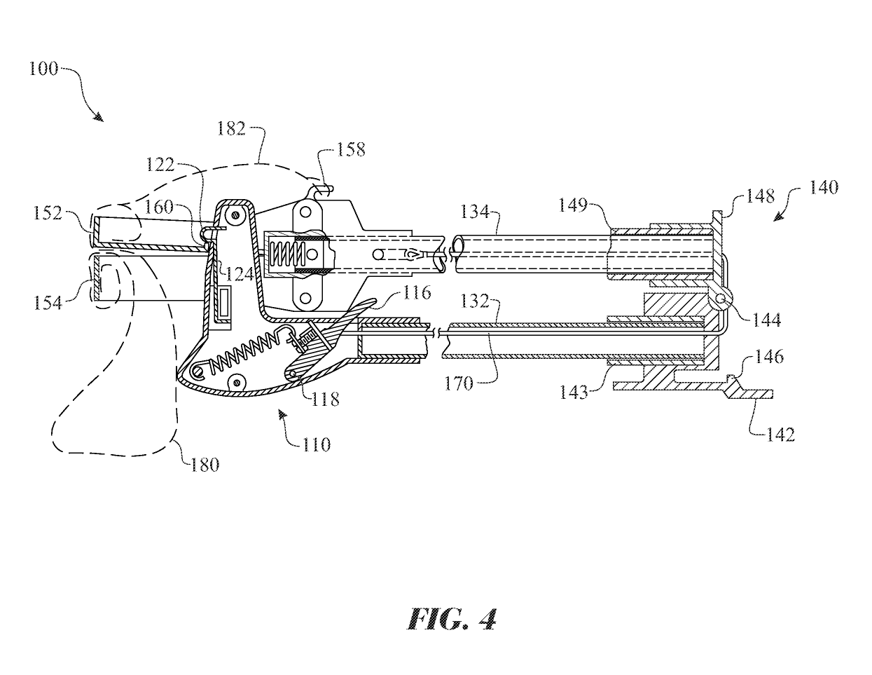

The handle extension subassembly 130 is assembled having an upper handle section 132 and a lower handle section 134 pivotally joined via the handle pivot subassembly 140. The upper handle section 132 and lower handle section 134 are fabricated of a tubular material, such as metal, plastic, a composite, and the like. The prototype is fabricated of an extruded tubular aluminum alloy. The handle pivot subassembly 140 is fabricated having an upper shaft latch coupler 143 and a lower shaft latch coupler 149 pivotally joined via a pivot pin 144 allowing the handle extension subassembly 130 to fold. The upper shaft latch coupler 143 and lower shaft latch coupler 149 are preferably fabricated of a molded plastic. It is understood that the upper shaft latch coupler 143 and the lower shaft latch coupler 149 can be fabricated of any reasonable material or combinations of materials and of a shape suitable for the application. The upper shaft latch coupler 143 is assembled to a pivot end of the upper handle section 132, preferably having a coupler design which slips over the exterior of the upper handle section 132. The lower shaft latch coupler 149 is assembled to a pivot end of the lower handle section 134, preferably having a coupler design which slips over the exterior of the lower handle section 134. One of the two members of the handle pivot subassembly 140 includes a pivot latch lever arm 142 for engaging with a pivot latch catch 148 of the opposite member. A pivot latch 146 is formed on the latching side of the pivot latch 146, such that the pivot latch 146 engages with the pivot latch catch 148, securing the upper handle section 132 in a linear configuration with the lower handle section 134. It is preferable that the pivot latch lever arm 142 be provided on the side, which is opposite the pivot pin 144. When the pivot latch 146 is disengaged from the pivot latch catch 148, the upper handle section 132 pivots towards the lower handle section 134, wherein the handle grip extension 114 can be inserted into a handle catch aperture 160. The grip closure latch 122 engages with a feature (such as an edge) of the handle catch aperture 160 securing the handle grip extension 114 to the waste collection subassembly 150, as best shown in FIG. 4. It is understood that the latching mechanism of the handle pivot subassembly 140 can be of any reasonable form factor known by those skilled in the art. An optional mid-shaft handle 136 can be provided for additional user handling purposes, the mid-shaft handle 136 being pivotally assembled to the animal waste handling device 100 via the pivot pin 144. It is also understood the handle extension subassembly 130 can be a single, non-pivoting tubular extension member.

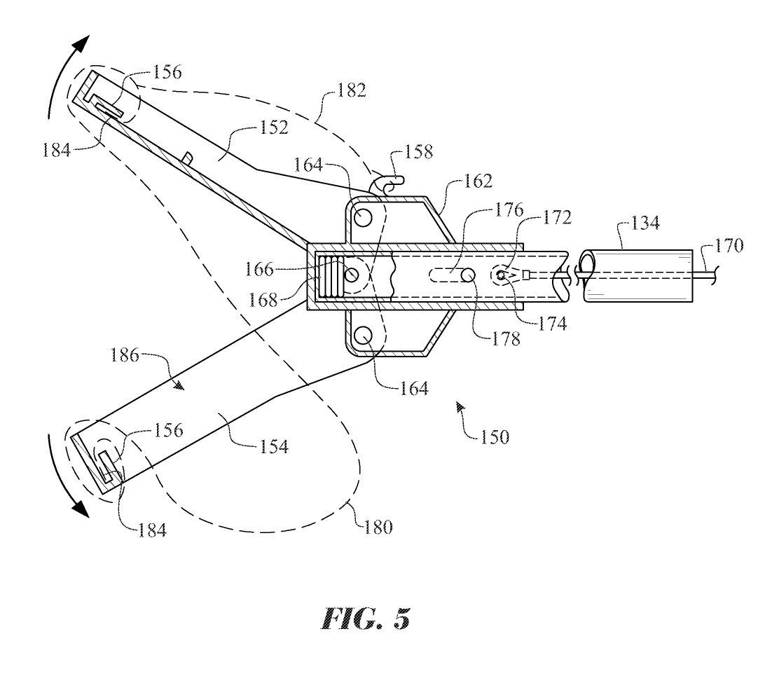

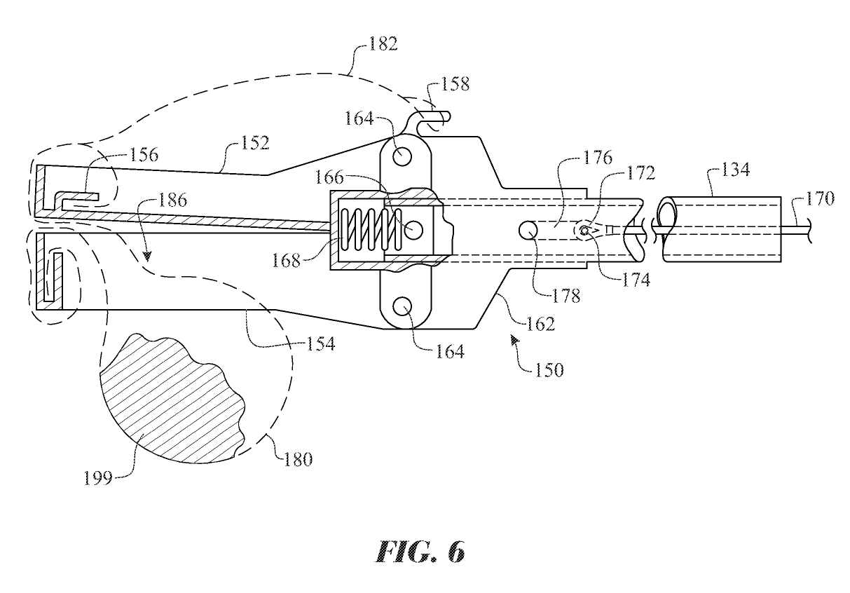

The components and functioning mechanisms of the waste collection subassembly 150 is best illustrated in FIG. 5, presenting the waste collection subassembly 150 in an open configuration and in FIG. 6, presenting the waste collection subassembly 150 in a closed configuration. A sliding handling arm control sleeve 162 is preferably formed of a molded plastic being slideably assembled to a collection end of the lower handle section 134. Pair of waste handling arms 152, 154 are each individually, pivotally assembled to the sliding handling arm control sleeve 162 via a respective cam pivot pin 164. A pivot portion is integrated into each of the upper waste handling arm 152 and lower waste handling arm 154, wherein the pivot portions overlap and are pivotally engaged via a handling arm pivot pin 166. The handling arm pivot pin 166 is additionally affixed to the lower handle section 134. The angle and span between the handling arm pivot pin 166 and the cam pivot pin 164 create a cam action. The sliding motion of the sliding handling arm control sleeve 162 is limited via a motion limiting slot 176 formed through the sidewalls of the lower handle section 134 having a motion limiting pin 178 positioned therethrough and secured to the sliding handling arm control sleeve 162. A biasing member 168 is positioned between a distal end of the sliding handling arm control sleeve 162 and the handling arm pivot pin 166. The biasing member 168 is preferably a compression spring, extending the sliding handling arm control sleeve 162 forward, thus maintaining the upper waste handling arm 152 and lower waste handling arm 154 in a normally closed configuration as illustrated in FIG. 6. An operating control cable 170 is secured acting as a tensile member between the sliding handling arm control sleeve 162 and the trigger 116. A collection end of the operating control cable 170 is secured to the sliding handling arm control sleeve 162 via a cable coupling loop 172 that is assembled to a cable coupling 174, the motion limiting pin 178 or any other similar feature. A trigger end of the operating control cable 170 is secured to the trigger 116 via a trigger cable coupler 128. The cable coupling loop 172 can be of any form factor known by those skilled in the art, including a clamping screw as illustrated, a bulbous end of the cable inserted into a receiving slot, a cable loop, and the like.

A waste disposal bag 180 is removably affixed to the waste handling arm 152, 154. The waste disposal bag 180 is assembled to the waste collection subassembly 150 by inserting a portion of a waste bag top 184 into a bag catch 156. The waste disposal bag 180 is inserted through a waste bag opening 186 formed through the lower waste handling arm 154. A bag closure string 182 is provided about the waste bag top 184 providing a means for closing the waste bag top 184. The bag closure string 182 is secured to a bag string hook 158 as illustrated in FIGS. 5 and 6. The waste collection subassembly 150 operated via applying a tension to the operating control cable 170 by pulling the trigger. The tension applied to the operating control cable 170 pulls the sliding handling arm control sleeve 162 against the spring biasing applied by the biasing member 168. As the sliding handling arm control sleeve 162 slides along the lower handle section 134, each of the cam pivot pin 164 provides a torque to the respective waste handling arm 152, 154, causing each of the respective waste handling arms 152, 154 to rotate and open the waste disposal bag 180. The user places the opening over the excrement 199 and releases the trigger 116. The biasing member 168 forces the sliding handling arm control sleeve 162 to move forward, closing the waste handling arms 152, 154, thus closing the waste disposal bag 180 over the excrement 199. The user then raises the containment end of the animal waste handling device 100, passing the excrement 199 to the sack portion of the waste disposal bag 180. The user releases the bag closure string 182 from the bag string hook 158 and pulls the bag closure string 182 sealing the waste disposal bag 180. The aperture sizes for each of the cam pivot pin 164 and the handling arm pivot pin 166 are such to avoid any binding during the rotational motion.

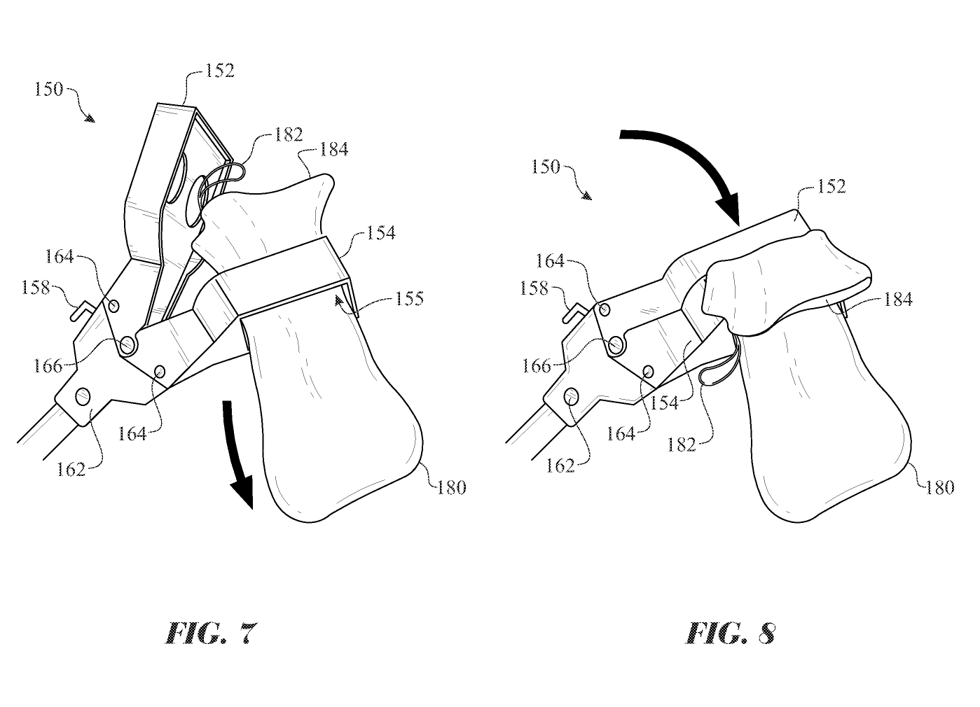

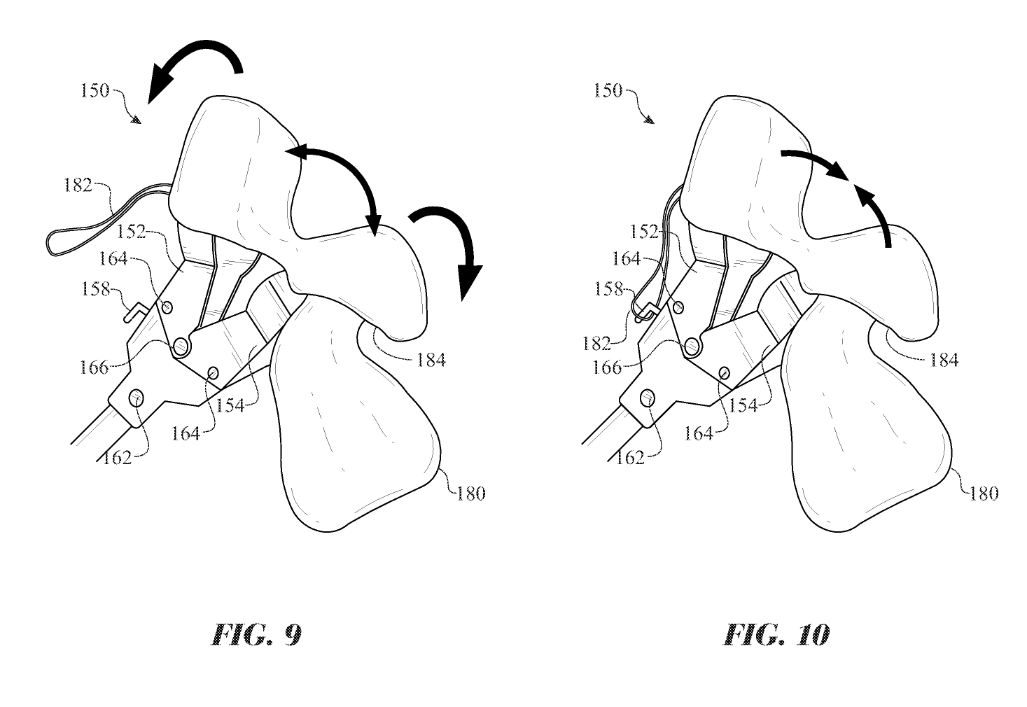

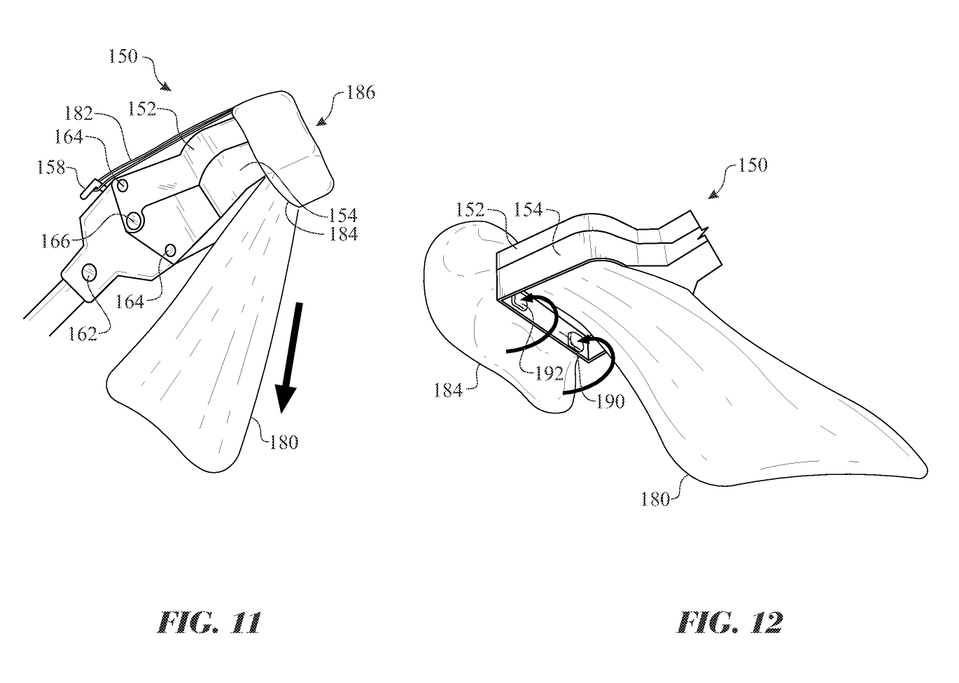

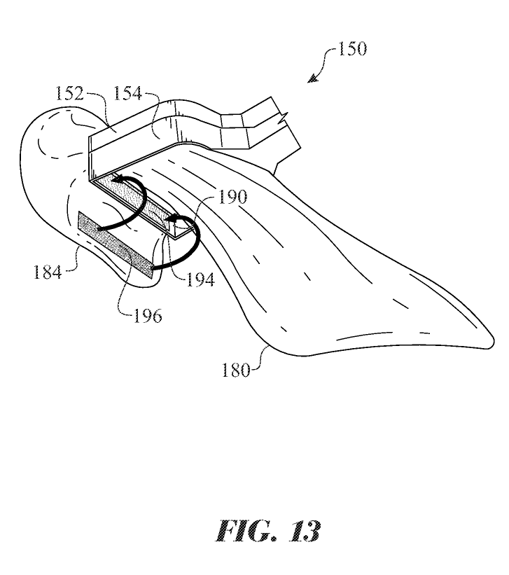

Details of the bag installation process are presented in FIGS. 7 through 12, with an alternate securing means presented in FIG. 13. The waste disposal bag 180 is inserted between the upper waste handling arm 152 and lower waste handling arm 154 and positioned through the bag and waste passage 155 as illustrated in FIG. 7. The waste bag top 184 is then folded outside the perimeter of the waste handling arms 152, 154 as illustrated in FIG. 8. The waste handling arms 152, 154 are repositioned into a closed configuration. The waste bag top 184 is then positioned about outer surfaces of the waste handling arms 152, 154 as illustrated in FIG. 9. The waste handling arms 152, 154 are opened; then the bag closure string 182 is looped about the bag string hook 158 as illustrated in FIG. 10. The waste handling arms 152, 154 are again repositioned into a closed configuration and the sack portion of the waste disposal bag 180 is pulled taught from the arms 152, 154. The waste bag top 184 can then be secured to a waste handling arm inner surface 190 of the lower waste handling arm 154 via any reasonable temporary fastening system. A tacky material 192 is applied to the waste handling arm inner surface 190, providing a reusable adhesive interface. The tacky material 192 can be a gum like substance, a double sided tape, and the like as illustrated in FIG. 12. Alternately, a strip of dense hook material 194 is adhered to the waste handling arm inner surface 190. A section of dense loop material 196 is provided upon a respective region of the waste disposal bag 180 proximate the waste bag top 184. The dense loop material 196 can be of blown plastic strands creating a fluffed cotton-like texture.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. An animal waste handling device, the device comprising:
a tubular handle extension;
a grip subassembly assembled to a grip end of the tubular handle extension, the grip subassembly comprising:
a grip housing,
a trigger pivotally assembled to the grip housing, and
a biasing member which maintains the trigger in an extended state; and
a waste collection subassembly comprising:
a sliding arm control sleeve being slideably assembled to the collection end of the tubular handle extension,
a pair of waste handling arms, comprising an upper waste handling arm and a lower handling arm, each comprising a waste handling frame and a cam element extending from angularly from a pivot aperture, the waste handling arms being pivotally assembled to the collection end of the tubular handle extension,
a cam pivot connector providing pivotal attachment of the cam element of each of the pair of waste handling arms to the sliding arm control sleeve; and
an operating control cable having a collection end attached to the sliding arm control sleeve and a trigger end attached to the trigger.

2. An animal waste handling device as recited in claim 1, the device further comprising a bag and waste passage provided through the lower handling arm.

3. An animal waste handling device as recited in claim 2, the device further comprising a waste disposal bag, the disposal bag being positioned through the bag and waste passage.

4. An animal waste handling device as recited in claim 3, the waste disposal bag further having a bag opening positioned between a collection end of each of the upper waste handling arm and the lower handling arm and wrapped upwards, partially covering the exterior of the waste handling arms.

5. An animal waste handling device as recited in claim 4, the lower handling arm further comprising a waste handling arm inner surface provided on the bag and waste passage side of a containment edge frame section, wherein the bag opening is secured to the waste handling arm inner surface via a releasable mechanical coupling interface.

6. An animal waste handling device as recited in claim 5, wherein the releasable mechanical coupling interface is selected from a releasable mechanical coupling interface consisting of:
a) a dense hook and loop tape, and
b) an adhesive.

7. An animal waste handling device as recited in claim 1, the device further comprising a waste disposal bag.

8. An animal waste handling device as recited in claim 1, the device further comprising a string bag hook provided upon one of the waste handling arms.

9. An animal waste handling device, the device comprising:
a handle subassembly comprising:
an upper handle section,
a lower handle section, and
a pivot subassembly which pivotally assembles the upper handle section and the lower handle section together, allowing the upper handle section and the lower handle section to be folded for a reduced overall length of the device;
a grip subassembly assembled to a grip end of the upper handle section, the grip subassembly comprising:
a grip housing,
a trigger pivotally assembled to the grip housing, and
a biasing member which maintains the trigger in an extended state; and
a waste collection subassembly comprising:
a sliding arm control sleeve being slideably assembled to the collection end of the lower handle section,
a pair of waste handling arms, each comprising a waste handling frame and a cam element extending from angularly from a pivot aperture, the waste handling arms being pivotally assembled to the collection end of the lower handle section,
a cam pivot connector providing pivotal attachment of the cam element of each of the pair of waste handling arms to the sliding arm control sleeve; and
an operating control cable having a collection end attached to the sliding arm control sleeve and a trigger end attached to the trigger.

10. An animal waste handling device as recited in claim 9, the device further comprising a bag and waste passage provided through the lower handling arm.

11. An animal waste handling device as recited in claim 10, the device further comprising a waste disposal bag, the disposal bag being positioned through the bag and waste passage.

12. An animal waste handling device as recited in claim 11, the waste disposal bag further having a bag opening positioned between a collection end of each of the upper waste handling arm and the lower handling arm and wrapped upwards, partially covering the exterior of the waste handling arms.

13. An animal waste handling device as recited in claim 12, the lower handling arm further comprising a waste handling arm inner surface provided on the bag and waste passage side of a containment edge frame section, wherein the bag opening is secured to the waste handling arm inner surface via a releasable mechanical coupling interface.

14. An animal waste handling device as recited in claim 13, wherein the releasable mechanical coupling interface is selected from a releasable mechanical coupling interface consisting of:
a) a dense hook and loop tape, and
b) an adhesive.

15. An animal waste handling device as recited in claim 9, the device further comprising a waste disposal bag.

16. An animal waste handling device as recited in claim 9, the device further comprising a string bag hook provided upon one of the waste handling arms.

17. An animal waste handling device, the device comprising:
a handle subassembly comprising:
an upper handle section,
a lower handle section,
a pivot subassembly comprising a pivot subassembly upper portion and a pivot subassembly lower portion, wherein the pivot subassembly upper portion is assembled to a pivot end of the upper handle section and the pivot subassembly lower portion is assembled to a pivot end of the lower handle section,
wherein the pivot subassembly pivotally assembles the upper handle section and the lower handle section together, allowing the upper handle section and the lower handle section to be folded for a reduced overall length of the device,
a pivot latch provided on one of the pivot subassembly upper portion and the pivot subassembly lower portion and a pivot latch catch provided on the other of the pivot subassembly upper portion and the pivot subassembly lower portion
a grip subassembly assembled to a grip end of the upper handle section, the grip subassembly comprising:
a grip housing,
a trigger pivotally assembled to the grip housing, and
a biasing member which maintains the trigger in an extended state; and
a waste collection subassembly comprising:
a pair of waste handling arms being pivotally assembled to the collection end of the lower handle section; and
an operating control cable having a collection end operably attached to the waste collection subassembly for operation of the pair of waste handling arms and a trigger end attached to the trigger.

18. An animal waste handling device as recited in claim 17, the waste collection subassembly further comprising a handle catch aperture for receiving a handle grip extension portion of the grip subassembly.

19. An animal waste handling device as recited in claim 18, the handle grip extension portion further comprising a grip latching element for securing the handle grip extension portion within the handle catch aperture.

20. An animal waste handling device as recited in claim 17, the waste collection subassembly further comprising:
a sliding arm control sleeve being slidably assembled to the collection end of the lower handle section,
a pair of waste handling arms, each comprising a waste handling frame and a cam element extending from angularly from a pivot aperture, the waste handling arms being pivotally assembled to the collection end of the lower handle section, and
a cam pivot connector providing pivotal attachment of the cam element of each of the pair of waste handling arms to the sliding arm control sleeve,
wherein the operating control cable is attached to the sliding arm control sleeve.
